(19) United States
(12) Patent Application Publication
(10) Pub. No.: US 2026/0177426 A1
(43) Pub. Date: Jun. 25, 2026

(54) MULTI-BAND OPTICAL FIBER TEMPERATURE SENSOR

(71) Applicant: Photon Control Inc., Richmond (CA)

(72) Inventors: Michael Feaver, Richmond (CA); Michael Bram Sadlik, Richmond (CA)

(73) Assignee: Photon Control Inc., Richmond (CA)

(21) Appl. No.: 19/125,407

(22) PCT Filed: Nov. 14, 2023
(86) PCT No.: PCT/CA2023/051515

§ 371 Date: Apr. 29, 2025

Related U.S. Application Data
(60) Provisional application No. 63/383,727, filed on Nov. 15, 2022.

(51) Int. Cl. G01J 3/02; G01J 3/28; G01N 21/64

(52) U.S. Cl. CPC G01J 3/0256; G01J 3/02; G01J 3/0208; G01J 3/2823; G01N 21/6408

(57) ABSTRACT

A multi-band fiber optic temperature sensor that is configured to provide an independence of temperature measurement from variations in the optical path. An apparatus described herein includes a phosphorescent time constant temperature sensor using one or more portions of the phosphor emission spectrum to measure more than one time-dependent parameter from the emission spectrum of one or more phosphors. Measuring the time dependent parameter (e.g., time decay or time constant of the intensity of the phosphorescence emission) in more than one different portion of the emission spectrum may result in improved accuracy and repeatability. Constraining the measurement of the time-dependent parameter to a portion of the emission spectrum may reduce the dependence of the time-dependent value on the attenuation spectrum of the optical pathway between the phosphor.

### CROSS-REFERENCE TO RELATED APPLICATION(S)

This application claims priority to U.S. Provisional Patent Application No. 63/383,727 filed on Nov. 15, 2022, the entire contents of which are herein incorporated by reference.

### TECHNICAL FIELD

The following generally relates to temperature sensors utilizing optical fibers, and particularly to fiber optic temperature sensors configured to individually process multiple bands of the emission spectrum to measure multiple parameters from such emission spectrum or to measure multiple point locations from the same type of sensor element.

### BACKGROUND

Existing thermographic phosphor temperature sensors utilize one or more characteristics that vary with temperature, for example phosphorescence emission intensity, time decay or the like. These sensors typically excite the phosphor using a laser or a light-emitting diode (LED) and measure the resulting emission intensity, for example by using a photodiode, or the spectral power distribution (SPD) of the emission using, for example a spectrometer or photodiode array or the like. An optical fiber optically couples the LED and photodiode (or other measurement means) to the phosphor, which is placed near to a target surface or is immersed in a measurement location at which temperature measurement is desired. A filter may be placed within the optical path to reduce the amount of stray light in the environment from reaching the photodiode. This filter passes the emission spectrum and blocks other wavelengths.

For systems utilizing a temperature-dependent characteristic of the phosphorescence emission, for example time constant or time decay these are considered as a bulk parameter in existing sensors. However, the time constant is found to vary over the emission wavelength spectrum and its consideration as a single parameter leads to dependence on the attenuation spectrum of the optical path. As some parts of the emission spectrum are more attenuated by the optical path than others, extending the length of the optical path leads to less light from these parts of the spectrum reaching the photodiode. Because the emission time constant varies across the emission spectrum, a bulk time constant measurement varies with the length of the optical path and its attenuation spectrum. This leads to inconsistency in time constant measurements between optical paths.

The phosphors are typically bound in a matrix, for example epoxy or silicone, and wavelength dependencies of the matrix may result in additional inconsistency in time constant measurements.

### SUMMARY

In one aspect, there is provided a temperature measurement system, comprising: a measurement module coupled to an optical path, the optical path terminating at a phosphor sensing element, the measurement module comprising: a light source optically coupled to the optical path to generate an optical excitation signal to excite the phosphor sensing element and generate an optical excitation response signal from the phosphor sensing element, wherein the optical excitation response signal includes an emission spectrum; one or more optical elements configured to separate the emission spectrum into a plurality of bands of the emission spectrum; and a plurality of detector elements to detect a respective one of the bands of the emission spectrum, thereby creating a detected signal for each of the plurality of bands of the emission spectrum; and a controller, coupled to the light source that generates the optical excitation signal, and coupled to the plurality of detector elements, to enable the temperature measurement system to process each detected signal, wherein the controller is configured to calculate the temperature of the phosphor sensing element based on at least one time-dependent parameter of at least one of the plurality of bands of the emission spectrum.

In certain example embodiments, the at least one time-dependent parameter comprises a measure of the decay of the emission intensity within at least one of the plurality of bands of the emission spectrum.

In certain example embodiments, the at least one time-dependent parameter comprises a time constant of the decay of the emission intensity within at least one of the plurality of bands of the emission spectrum.

In certain example embodiments, the controller is configured to modulate the optical excitation signal.

In certain example embodiments, at least one of the one or more optical elements comprises at least one dichroic mirror.

In certain example embodiments, the measurement module further comprises a plurality of channels, each of the plurality of channels comprising at least one of the one or more optical elements, a filter, and one of the plurality of detector elements.

In certain example embodiments, the measurement module is configured to determine a time-dependent parameter of the decay of the emission intensity of the emission spectrum in at least one of the plurality of channels and to use the time-dependent parameter in the at least one of the plurality of channels in the determination of the temperature of the phosphor sensing element.

In certain example embodiments, the measurement module is configured to determine a time constant of the decay of the emission intensity of the emission spectrum in at least one of the plurality of channels and to use the time constant in the at least one of the plurality of channels in the determination of the temperature of the phosphor sensing element.

In certain example embodiments, the measurement module comprises a plurality of index matching elements optically connected to a core of an optical fiber that provides the optical path, each of the plurality of index matching elements being optically connected to the controller through the optical path.

In certain example embodiments, each of the plurality of index matching elements comprise at least one phosphor sensing element and at least one filter.

In certain example embodiments, the at least one filter comprises at least one of a bandpass filter, a low pass filter or a high pass filter and the at least one filter is characterized by a transmission spectrum.

In certain example embodiments, (i) the optical path has a first index of refraction and (ii) the plurality of index matching elements is index matched to the first index of refraction.

In certain example embodiments, (i) the optical path comprises an optical fiber comprised of a core region and a cladding region, (ii) the core region has a first index of refraction and (iii) the plurality of index matching elements are index matched to the first index of refraction.

In certain example embodiments, each of the plurality of phosphor sensing elements are the same and a filter in a first channel has a different transmission spectrum than a filter in a second channel, where the first channel is different from the second channel.

In certain example embodiments, the phosphor sensing element associated with a first channel is different from a phosphor sensing element associated with a second channel, different from the first channel, and a filter in the first channel has a different transmission spectrum than the filter in the second channel, where the first channel is different from the second channel.

In certain example embodiments, the system further comprise a computing device coupled to the controller.

In certain example embodiments, the light source comprises at least one of a light emitting diode (LED) and a laser.

In certain example embodiments, the measurement module comprises a spectrometer.

In certain example embodiments, the spectrometer is a Czerny-Turner spectrometer.

In certain example embodiments, the measurement module further comprises a photodiode array coupled to the spectrometer via a plurality of optical paths.

In certain example embodiments, the measurement module comprises a photodiode array as part of the spectrometer.

In another aspect, there is provided a temperature measurement system, comprising: a plurality of branches of a common optical path, each of the plurality of the branches terminating at a sensing location, each sensing location comprising a filter disposed between one of the plurality of branches of the common optical path and a phosphor sensing element, a measurement module coupled to the common optical path, the measurement module comprising: a light source optically coupled to the common optical path to generate an optical excitation signal to excite each phosphor sensing element and generate an optical excitation response signal from each of the phosphor sensing elements, wherein (i) the optical excitation response signal comprises an emission spectrum, (ii) each filter is configured to pass a band of the emission spectrum, thereby creating a plurality of filtered excitation response signals and (iii) each of the plurality of filtered optical excitation response signals are optically coupled into the common optical path; one or more optical elements to separate the plurality of filtered optical excitation response signals into a plurality of detection channels; and a plurality of detector elements configured to detect a respective one of the plurality of filtered optical excitation response signals to process a respective band of the emission spectrum; and a controller coupled to the light source to generate the optical excitation signal, and coupled to the plurality of detector elements, to enable the measurement system to process the plurality of filtered optical excitation response signals, wherein the controller is configured to calculate the temperature of the sensing element based on at least one time-dependent parameter of an emission intensity within at least one of the bands of the emission spectrum.

In certain example embodiments, the time-dependent parameter comprises a measure of the decay of the emission intensity within at least one of the bands of the emission spectrum.

In certain example embodiments, the time-dependent parameter comprises a time constant of the decay of the emission intensity within at least one of the bands of the emission spectrum.

In certain example embodiments, the controller is configured to modulate the optical excitation signal.

In certain example embodiments, the one or more optical elements comprises at least one dichroic mirror.

In certain example embodiments, the measurement module further comprises a plurality of channels, each channel comprising at least one of the optical elements, a filter, and one of the plurality of detectors.

In certain example embodiments, the measurement module is configured to determine a time-dependent parameter of the decay of the emission intensity of the emission spectrum in at least one of the plurality of channels and to use the time-dependent parameter in the at least one of the plurality of channels in the determination of the temperature of the sensing element.

In certain example embodiments, the measurement module is configured to determine a time constant of the decay of the emission intensity of the emission spectrum in at least one of the plurality of channels and to use the time constant in the at least one of the plurality of channels in the determination of the temperature of the sensing element.

In certain example embodiments, the at least one filter comprises at least one of a bandpass filter, a low pass filter or a high pass filter and the at least one filter are characterized by a transmission spectrum.

In certain example embodiments, the system further comprises a computing device coupled to the controller.

In certain example embodiments, the light source comprises a light emitting diode (LED) or a laser.

In certain example embodiments, the measurement module comprises a spectrometer.

In certain example embodiments, the spectrometer is a Czerny-Turner spectrometer.

In certain example embodiments, the measurement module further comprises a photodiode array coupled to the spectrometer via a plurality of optical paths.

In certain example embodiments, the measurement module comprises a photodiode array as part of a spectrometer.

In certain example embodiments, the measurement module comprises a plurality of index matching elements optically connected to a core of an optical fiber that provides the optical path, each index matching element being optically connected to the controller through an optical path.

In certain example embodiments, each of the plurality of index matching elements comprise at least one phosphor sensing element and at least one filter.

In certain example embodiments, the at least one filter comprises at least one of a bandpass filter, a low pass filter or a high pass filter, wherein the at least one filter is characterized by a transmission spectrum.

In certain example embodiments, (i) the optical path has a first index of refraction and (ii) each of the plurality of index matching elements is index matched to the first index of refraction.

In certain example embodiments, (i) the optical path comprises an optical fiber comprised of a core region and a cladding region, (ii) the core region has a first index of refraction and (iii) each of the plurality of index matching elements is index matched to the first index of refraction.

In certain example embodiments, each of the plurality of phosphor sensing elements are the same and a filter in a first channel has a different transmission spectrum than a filter in a second channel, where the first channel is different from the second channel.

In certain example embodiments, a phosphor sensing element associated with a first channel is different from a phosphor sensing element associated with a second channel, different from the first channel, and a filter in the first channel has a different transmission spectrum than the filter in a second channel, where the first channel is different from the second channel.

In certain example embodiments, each phosphor element is positioned to perform a measurement at a separate location of a measured object or to measure a plurality of separate objects.

In another aspect, there is provided a method, comprising: transmitting a light signal along an optical path to excite a phosphor sensing element optically coupled to the optical path; receiving a return signal comprising an emission spectrum; dividing the return signal into a plurality of bands of the emission spectrum; directing each of the plurality of bands of the emission spectrum to a corresponding detector element, wherein each detector element creates a detected signal; applying signal processing to each detected signal comprising a respective band of the emission spectrum; and determining the temperature of the phosphor sensing element based on at least one time-dependent parameter of at least one of the plurality of bands of the emission spectrum.

In certain example embodiments, the time-dependent parameter comprises a measure of the decay of the emission intensity within at least one of the plurality of bands of the emission spectrum.

In certain example embodiments, the time-dependent parameter comprises a time constant of the decay of the emission intensity within at least one of the plurality of bands of the emission spectrum.

In certain example embodiments, the light signal is modulated.

In another aspect, there is provided a method, comprising: transmitting a light signal along a common optical path that is coupled to a plurality of branches to excite a plurality of phosphor sensing elements, each of the plurality of phosphor sensing elements being coupled to a respective branch of the common optical path; receiving a plurality of return signals via the common optical path, each of the plurality of return signals having been filtered to provide one of a plurality of bands of an emission spectrum of the respective phosphor sensing element; directing each of the plurality of return signals to a respective measurement channel, wherein each respective measurement channel includes at least one detector, wherein each of the at least one detector creates a respective detected signal; applying signal processing to each respective detected signal to obtain a measurement for a respective one of the plurality of phosphor sensing elements; and determining the temperature of the phosphor sensing element based on at least one time-dependent parameter of at least one band of the emission spectrum.

In certain example embodiments, the time-dependent parameter comprises a measure of the decay of the emission intensity within at least one of the plurality of bands of the emission spectrum.

In certain example embodiments, the time-dependent parameter comprises a time constant of the decay of the emission intensity within at least one of the plurality of bands of the emission spectrum.

In certain example embodiments, the light signal is modulated.

### BRIEF DESCRIPTION OF THE DRAWINGS

Example embodiments will now be described with reference to the appended drawings, wherein:

FIG. 1 is a schematic diagram of an example embodiment of a fiber optic temperature sensor configured to detect multiple bands of a phosphor emission spectrum.

FIG. 2A is a schematic diagram of an example embodiment of a fiber optic temperature sensor configured to measure temperature at multiple locations by filtering each measurement source to detect within a selected band of the phosphor emission spectrum filtered at that measurement source.

FIG. 2B illustrates the spectrum that may be transmitted from the sensing element in the fiber optic temperature sensor shown in FIG. 1.

FIG. 3 is a schematic diagram showing an example embodiment for measuring signals in multiple bands of the phosphor emission spectrum.

FIGS. 4A and 4B are schematic diagrams showing example embodiments for measuring signals in multiple bands of the phosphor emission spectrum.

FIG. 5 is a schematic diagram showing an example embodiment for measuring temperature at multiple locations.

FIG. 6 is a schematic diagram showing an example embodiment for measuring temperature at multiple locations along an optical path using index matching elements.

FIG. 7 illustrates a phosphor emission spectrum in an example embodiment for decomposing an emission spectrum.

FIG. 8 illustrates a dichroic filter transmittance spectrum applied to the phosphor emission spectrum of FIG. 7.

FIG. 9 illustrates filter band passes applied to the phosphor emission spectrum of FIG. 7.

FIG. 10 illustrates the spectrum reaching each of two photodiodes based on the filter band passes shown in FIG. 9.

FIG. 11 illustrates a decomposition process to improve a parameter or variable estimation according to the example process depicted in FIGS. 7-10.

FIG. 12 is a flow chart illustrating example operations that can be performed in decomposing an emission spectrum to improve a parameter or variable estimation.

FIG. 13 illustrates phosphor emission spectrum from a pair of sensors in a multiple sensor transmission embodiment.

FIG. 14 illustrates filter band passes over the sensor emission spectrums shown in FIG. 13.

FIG. 15 illustrates a pair of signals obtained from the filter band passes shown in FIG. 14.

FIG. 16 illustrates the pair of signals passed through a common optical fiber.

FIG. 17 illustrates a dichroic filter applied to the pair of signals.

FIG. 18 illustrates filter band passes applied to the signals shown in FIG. 17.

FIG. 19 illustrates a pair of signals having different decay rates.

FIG. 20 illustrates a multiple sensor transmission embodiment over one optical path according to the example process depicted in FIGS. 13-19.

FIG. 21 is a flow chart illustrating example operations that can be performed in obtaining multiple sensor signals over a single optical path.

### DETAILED DESCRIPTION

The following provides a multi-band fiber optic temperature sensor that is configured to provide an independence of temperature measurement from variation in the optical path, among other things.

In one aspect, the system and apparatus described herein includes a, phosphorescent time constant temperature sensor using one or more portions of the emission spectrum to measure more than one time-dependent parameter from the emission spectrum of one or more phosphors (e.g., time-constant(s)). Measuring the time dependent parameter, for example time decay or time constant of the intensity of the phosphorescence emission) in a portion of the emission spectrum or in more than one different portion of the emission spectrum may result in improved accuracy and repeatability. Constraining the measurement of the time-dependent parameter to a portion of the emission spectrum may reduce the dependence of the time-dependent value on the attenuation spectrum (or frequency response) of the optical pathway between the phosphor and the detector and/or the attenuation spectrum of the matrix in which the phosphor is disposed. For example, one or more portions of the emission spectrum to be evaluated may be chosen to overlap or coincide with regions of the attenuation spectrum of the optical path or matrix that are relatively flat, i.e. that exhibit little to no variation in the attenuation with wavelength.

Moreover, the example embodiments described herein may enable consideration of relative time-dependent parameter changes in different parts of the emission spectrum. Furthermore, example embodiments described herein may enable the measurement of multiple phosphor elements of the same type using a single optical fiber by measuring different parts of the emission band from each phosphor element.

In one example embodiment, at least one phosphor or combination of phosphors can be located to measure temperature and can be connected via an optical path to an excitation light source and multiple emission optical detectors, which may be provided using multiple photodiodes, a photodetector array, a complementary metal-oxide-semiconductor (CMOS) detector, a charge-coupled device (CCD), or any other suitable set of optical detectors, each of which is capable of measuring a different band within the emission spectrum. Each optical detector can be connected to an electronic circuit that measures a parameter of the phosphorescent decay such as time constant.

The fiber optic temperature sensor embodiments described herein may be used to measure phosphorescent time decay more accurately. Since phosphorescent decay may be parameterized in other ways, such as phase shift, the example embodiments described herein can also be used to measure multiple parameters of the phosphorescent decay, and to perform relative measurements of phosphorescent decays at different bands within the emission spectrum.

The fiber optic temperature sensor arrangements described herein may also be used to measure multiple phosphors at different locations by considering one or more bands within the emission spectrum from each phosphor.

Advantages of the embodiments, configurations, and implementations described herein can include greater accuracy and independence from variation in the attenuation of the optical path. The accuracy advantage can be derived from measuring within a narrow band of the emission spectrum in which the time constant has less variability than the bulk emission spectrum. Separating the emission spectrum into bands allows for each band to be considered independently while measuring signals from across the emission spectrum.

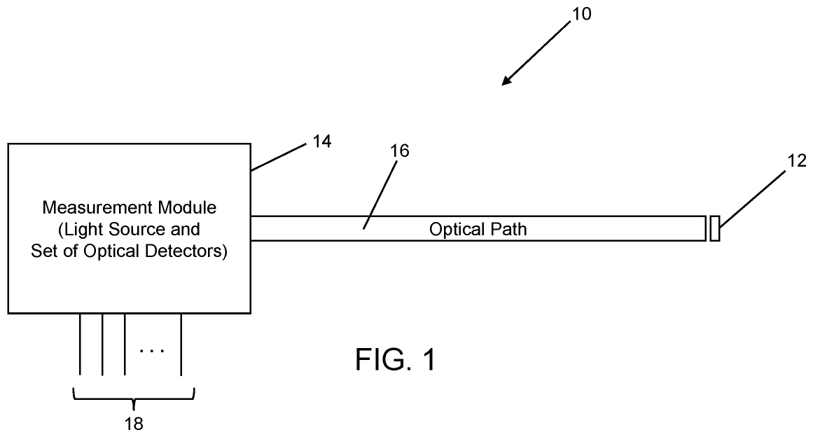

FIG. 1 illustrates an example embodiment of a fiber optic temperature sensing system 10, which is configured to detect one of a plurality of bands within the phosphor emission spectrum. In this example embodiment, the fiber optic temperature sensing system 10 includes a phosphor sensing element 12 (also referred to herein as a sensing element 12″) that is supported by or otherwise optically coupled to a temperature probe or other structure (not shown) and connected to a measurement module 14 via an optical path 16. The measurement module 14 includes an opto-electrical circuit or sub-system that can detect and produce a set of outputs 18, each indicative of a parameter, for example a time-dependent parameter, measured in a distinct band of the emission spectrum. The optical path 16 may be provided as an optical fiber, light guide, free space, etc.

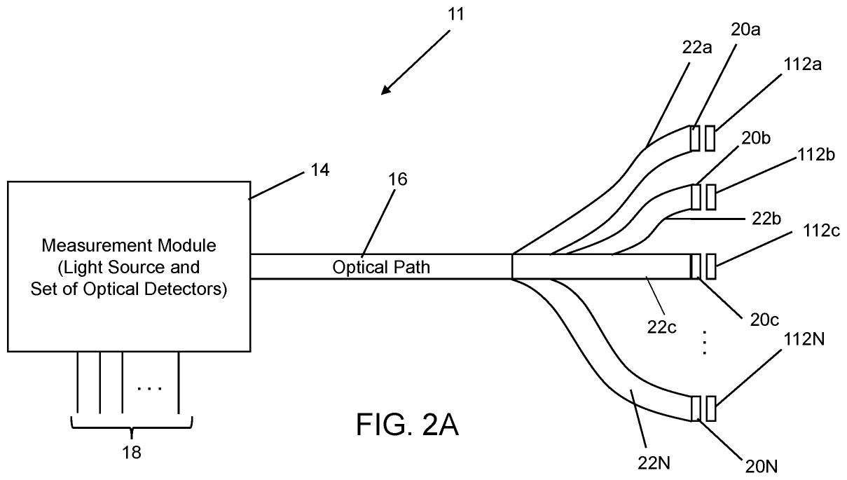

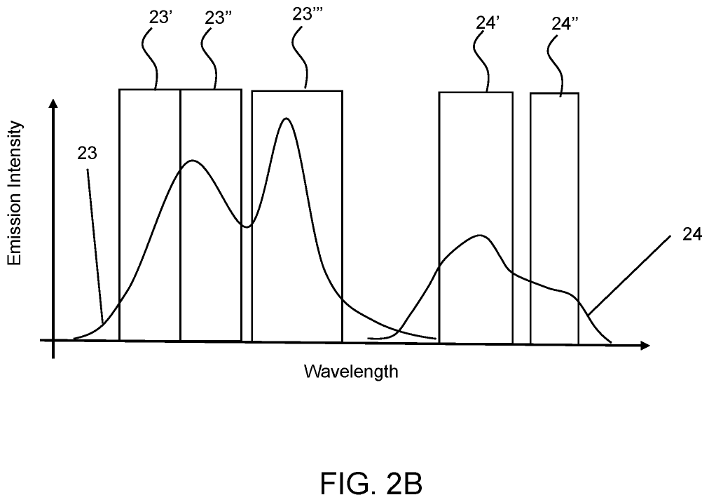

FIG. 2A illustrates an example embodiment of a fiber optic temperature sensing system 11, which is configured to utilize at least one of the plurality of bands of the emission spectrum to enable the same optical path 16 and measurement module 14 to be coupled to branched optical paths (22a, 22b, . . . 22N) that are connected to the optical path 16 via a splitter or other optical connectors (not shown in FIG. 2A to simplify the diagram), to obtain measurements from multiple sensing elements 112a, 112b, 112c, . . . , 112N utilizing the same type of phosphorescent material (e.g., using standard elements such as splitters or couplers). Each phosphor element can be positioned to perform a measurement at a separate location of a measured object or to measure multiple separate objects (that may or may not be different) and produce a set of outputs 18, each indicative of a parameter, for example a time-dependent parameter, measured in a distinct band of the emission spectrum that may be associated with a different location.

In the example embodiment shown in FIG. 2A, each measurement location has a sensing element 112 and a filter element 20 (with filter elements 20a, 20b, 20c, . . . , 20N shown) to isolate the corresponding band from the emission spectrum for that sensing point. In this way, the measurement module 14 can detect and produce a set of outputs 118, each indicative of a measurement taken from a respective one of the sensing elements 112. The filter elements 20 are each configured to pass the corresponding band that is being used for the respective sensing element 112. For example, in the example embodiment shown in FIG. 2A, the sensing element 112a uses a specific band pass filter element 20a such that the measurement module 14 can correlate measurements in that band to the specific temperature sensing location at which the sensing element 112a is being used. Similarly, sensing element 112b uses a specific band pass filter element 20b to utilize another specific band of the emissions spectrum for another sensing location, and so forth with the remaining elements c, . . . N.

While the sensing elements 112a, 112b, 112c, . . . , 112N have been described as utilizing the same type of phosphorescent material, this is not a limitation of the invention and in other embodiments different sensing elements may utilize different phosphorescent materials. In various embodiments more than one type of phosphorescent material may be used for various reasons. For example, in various embodiments, different phosphorescent materials (or phosphors) may be used when one or more locations may have a different temperature range to be measured than one or more other locations, and the type of phosphor may be chosen or optimized to best match the temperature range of each location. For example the phosphor may be chosen based on emission intensity, the time decay value or other parameters, both time-independent and time-dependent, for each temperature range. In various embodiments one or more phosphors may be chosen to have spectral power distributions that at least in part do not overlap. This may allow an increase in the number of locations that may be measured by extending the total wavelength range that may be accessed by the system.

FIG. 2B shows an example spectrum that may be transmitted from the sensing element to measurement module 14. While the spectrum shown in FIG. 2B is comprised of the emission spectra of two different phosphors identified as 23 and 24, this is not a limitation of the present disclosure, and in other embodiments it may be comprised of the emission spectrum of one type of phosphor or of more than two different types of phosphor.

Referring to FIG. 1, the sensing element 12 may have an emission spectrum as exemplified by spectrum 23 in FIG. 2B. In various embodiments, emission spectrum 23 may be divided into more than one band, for example bands 23′, 23″ and 23′″. In various embodiments, the bands may be adjacent to each other, as exemplified by bands 23′ and 23″ and/or they may be separated from each other, as exemplified by bands 23″ and 23′″.

Referring to FIG. 1, the sensing element 12 may have an emission spectrum as exemplified by spectrum 23 in FIG. 2B. In various embodiments emission spectrum 23 may be divided into more than one band, for example bands 23′, 23″ and 23′″. In various embodiments, one or more time-dependent parameters, for example time decay or time constant, and/or time-independent parameters, for example integrated intensity over the band, may be determined in each band and these may be used individually or collectively to determine or calculate the temperature of phosphor sensing element 12. In various embodiments, the values of one or more parameters may be used in this determination, while in other embodiments ratios of such values may be used.

Referring to FIG. 2A, the sensing elements 112a, 112b, 112c, . . . , 112N may be the same or substantially the same and the sensing elements 112a, 112b, 112c (only three sensing elements are discussed with reference to FIG. 2B) may each have an emission spectrum as exemplified by spectrum 23 in FIG. 2B. In various embodiments, the emission spectrum 23 may be divided into more than one band, for example, bands 23′, 23″ and 23′″ which correspond to the filtered emission spectra in optical paths 22a, 22b and 22c of FIG. 2A respectively. In various embodiments, one or more time-dependent parameters, for example time decay or time constant, and/or time-independent parameters, for example, integrated intensity over the band, may be determined in each band and these may be used individually or collectively to determine or calculate the temperature of the sensing elements 112a, 112b, 112c. In various embodiments, the values of one or more time parameters may be used in this determination, while in other embodiments ratios of such values may be used.

FIG. 2B shows the spectra of two sensing elements or phosphors 23 and 24. In various embodiments, the sensing element 12 of FIG. 1 may comprise more than one phosphor, for example to extend the temperature range of the sensing system. For example, in various embodiments one phosphor may provide more accurate temperature determination over a lower temperature range while a different phosphor may provide more accurate temperature determination over a higher temperature range. In various embodiments the parameters determined from each band (23′, 23″ and 23′″ from phosphor 23 and 24′, 24″ from phosphor 24) may be used to calculate or determine a temperature and collectively used to determine a more accurate temperature value or the one or more parameters from each band may be evaluated and the temperature may be calculated using the one or more parameters from one or a portion of the bands.

In various embodiments, the spectrum of one sensing element or phosphor may not provide enough differentiated temperature dependent values to meet the number of desired locations to be measured and two or more phosphors may be used to extend the number of discrete locations. For example, in various embodiments, a portion of the sensing elements 112a, 112b, 112c, . . . , 112N may comprise one phosphor and a different portion of the sensing elements 112a, 112b, 112c, . . . , 112N may comprise a different phosphor. While FIG. 2B shows the spectrum of two different phosphors, this is not a limitation and in other embodiments more than two different phosphors may be utilized.

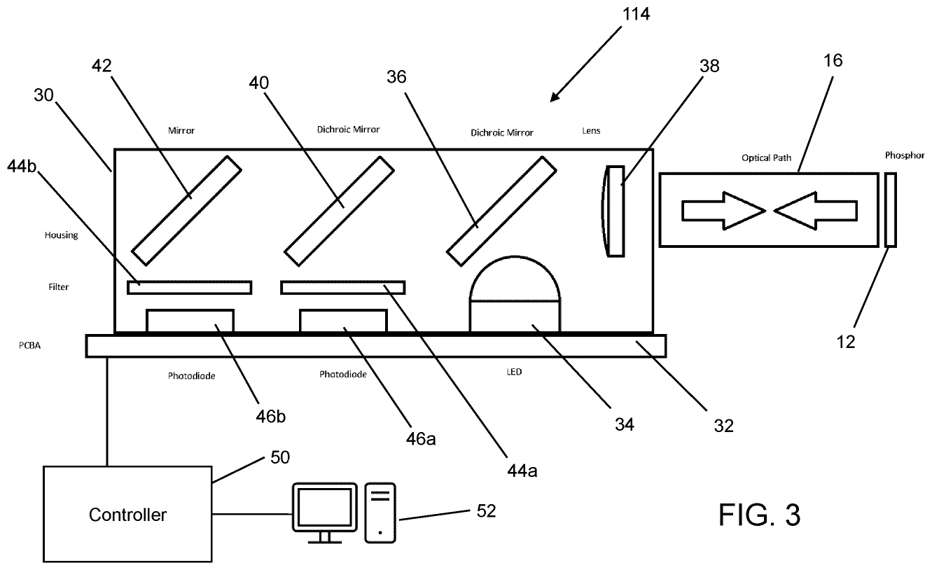

Referring now to FIG. 3, an example embodiment of the measurement module 14 is shown and denoted by numeral 114. In this example, the measurement module 114 includes a casing or housing 30 to contain the optical elements. The housing 30 contains or mounts to a printed circuit board assembly (PCBA) 32 that includes a laser or light-emitting diode (LED) 34 provided as a light source to emit an optical excitation signal to excite the phosphor sensing element 12 through the optical path 16 and a plurality of photodiodes (e.g., 46a, 46b, also referred to herein as “detector devices” or “detector elements”). The phosphor sensing element is configured to emit at least one optical excitation response signal having an emission spectrum. While the example in FIG. 3 illustrates a pair of photodiodes 46a, 46b, it can be appreciated that more can be included in the module 114, e.g., to isolate additional bands of the emissions spectrum (generally referred to herein as N number of a plurality of channels 1, 2, . . . N). The module 114 also includes a lens 38 and dichroic mirror 36 that are positioned to reflect and focus light being emitted by the LED 34 into the optical fiber (or other optical element) providing the optical path 16 while allowing light emitted by the phosphor 12 to pass through and towards a dichroic mirror 40 aligned with the first photodiode 46a, and a mirror 42 aligned with the second photodiode 46b. The dichroic mirror 40 reflects light of a lower wavelength toward the filter 44a and the photodiode 46a and transmits light of a higher wavelength toward the mirror 42, the filter 44b and the photodiode 46b. It can be appreciated that the filters 44a, 44b may be omitted since the dichroic mirror 40 performs a filtering function. However, in this example, the filters 44a, 44b are used to further constrain the wavelength range that reaches each photodiode 46a, 46b. For example, if it is found that there is some wavelength range over which the dichroic mirror 40 goes from a very low transmittance to a very high transmittance and/or there is found to be angular placement variability between dichroic filters, the filters 44a, 44b may be placed as shown in this example. The first photodiode 46a detects light permitted to pass through a first filter 44a, which filters the reflected light to permit a band of the emissions spectrum for that photodiode 46a to process. Similarly, the second photodiode 46b detects light permitted to pass through a second filter 44b, which filters the reflected light to permit another band of the emission spectrum for that photodiode 46b to process.

Signals detected by the photodiodes 46a, 46b can be provided to a controller 50, which may also be coupled to the PCBA 32 to enable the controller 50 to control the operation of the LED 34. In this example embodiment, the controller 50 may be operated by another computing device 52, e.g., a computing workstation in a measurement, testing, or manufacturing environment or can be operated in a self-contained configuration. The controller 50 may be used for various functions and operations. For example, the controller 50 may be used to adjust the gain of a transimpedance amplifier (not shown) that converts the current signal from the photodiode 46a, 46b to a voltage signal. The controller 50 may also be used to control the duration of the on and off time or the current of the LED 34. In various embodiments, the LED 34 may be modulated to turn off and on, for example by a square wave, and the temperature dependent value, for example a time decay value or time constant, may be determined after the LED is turned off. In various embodiments, the phosphor 12 may be excited by a sine wave and the emission of the phosphor 12 would be a sine wave that is shifted in phase from the excitation wave. The phase shift and amplitude changes can be used to measure temperature. The length of the decay can also be controlled. Moreover, in a different way of exciting a phosphor, the period, amplitude, and offset of a sine wave (used instead of a square wave) can also be controlled. While a computing workstation is shown in FIG. 3, it can be appreciated that various other computing devices 52 may be used. For example, a typical control system used to control the photodiodes 46a, 46b and LED 34 may interface with another communication interface (not shown), which communicates over a communication protocol such as RS232, RS485 (or other serial protocol), TCP/IP, EtherCAT, analog 4-to-20 mA, analog 0-to-10V, to name a few. In such an example embodiment, an external programmable logic controller (PLC), a readout, or a master can be provided, which may or may not utilize a computing workstation to communicate with the communication module.

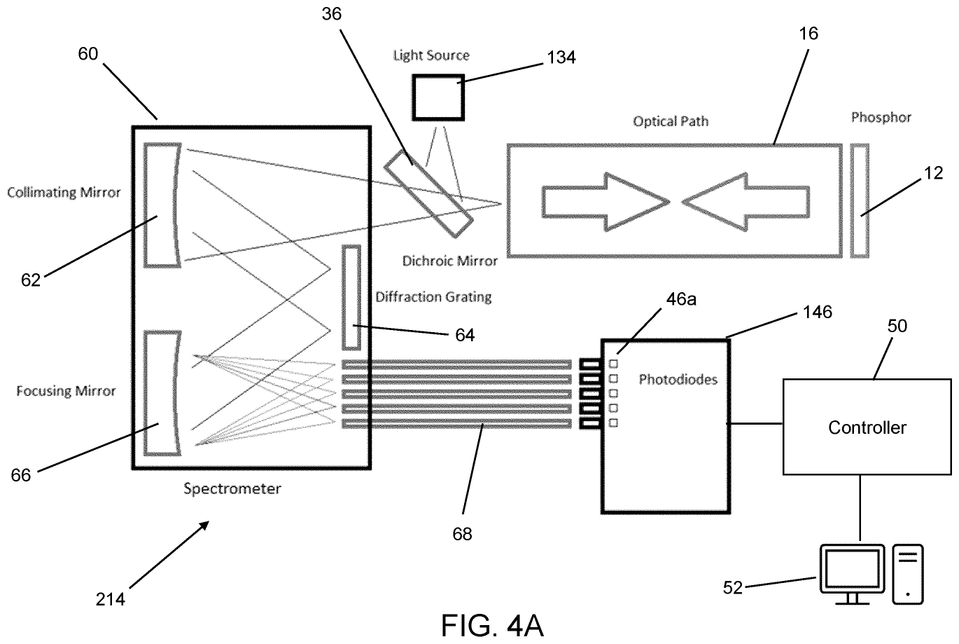

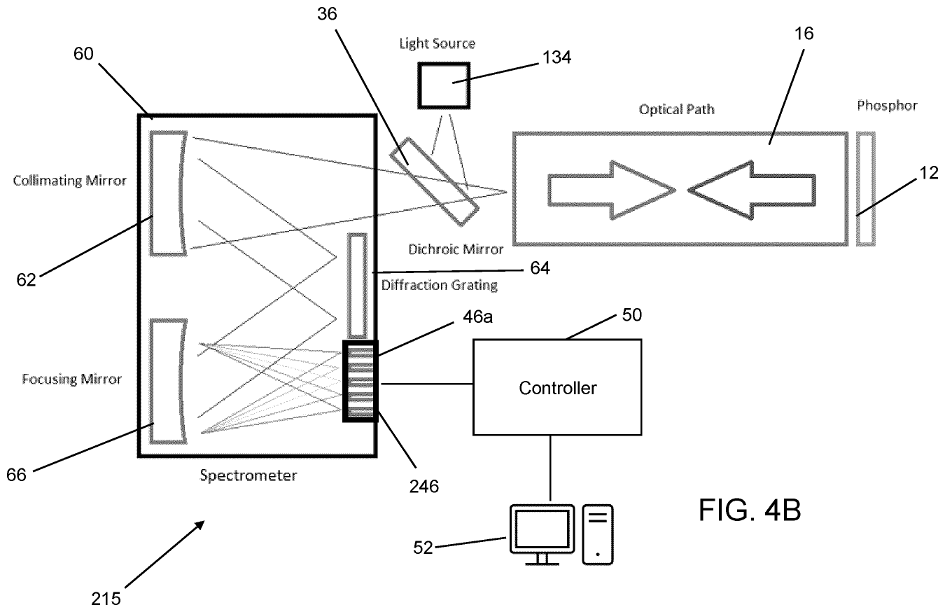

FIG. 4A illustrates another example embodiment of the measurement module 14, denoted by numeral 214. In this example, the measurement module 214 includes a Czerny-Turner spectrometer 60, a dichroic mirror 36, and a light source 134. The light source 134 is aligned with the dichroic mirror 36 to direct a beam of light into the optical fiber providing the optical path 16 towards the phosphor element 12. The light emitted by the phosphor element 12 passes through the dichroic mirror into the spectrometer 60 towards a collimating mirror 62 to collimate the returned light towards a diffraction grating 64. The diffraction grating 64 disperses the returned light so that its spectrum is focused by the focusing mirror 66 along a line depending on its wavelength. Linearly distributed optical elements, which may be implemented using a series of optical fibers 68, connect each wavelength band to a separate photodiode element or to separate pixels on a CCD or CMOS device. The photodiode module 146, which includes a number of photodiodes 46a, 46b, . . . 46N, can be coupled to a controller 50 and computing device 52 as in the example embodiment shown in FIG. 3. Moreover, FIG. 4B, illustrates another example embodiment of the measurement module 14, denoted by numeral 215 in FIG. 4B. The photodiode array 246 of photodiodes 46a, 46b, . . . 46N can be placed inside the spectrometer 60 in such other devices.

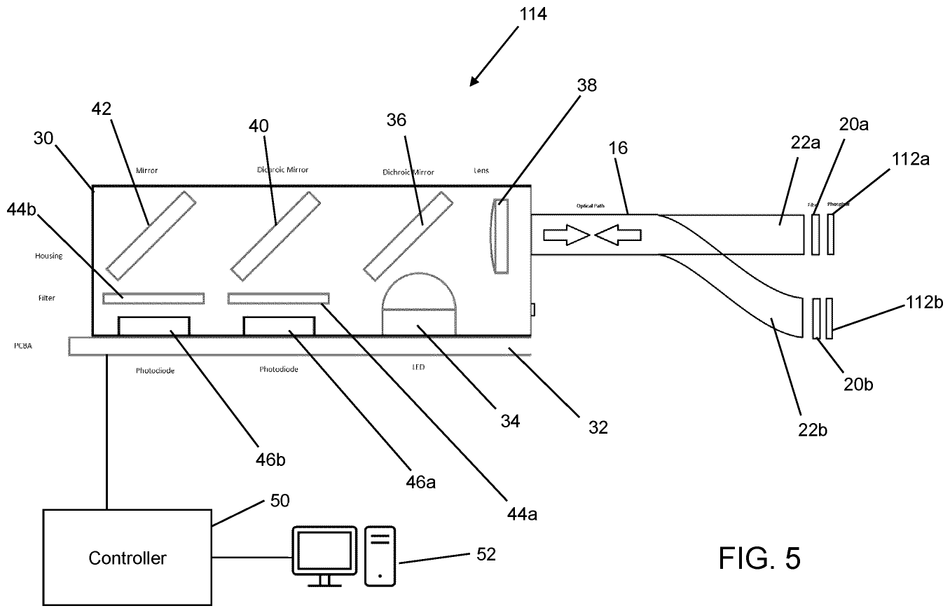

FIG. 5 illustrates another example embodiment, in which the measurement module 114 shown in FIG. 3 is utilized with a multi-point optical path 16 as illustrated in FIG. 2A. The optical path 16 shown in FIG. 5 may be coupled to paths 22a, 22b in this example using a splitter or coupler, which can be off-the-shelf components. Filters 20a, 20b adjacent to the phosphors 112a, 112b are used along with the filters 44a, 44b in the module 114 (see also FIG. 3) to separately distinguish the temperature at each phosphor element 112a, 112b, etc. That is, the filter 20a corresponds to the filter 44a (i.e., would be the same filter as), and the filter 20b corresponds to the filter 44b (i.e., would be the same filter as), to allow for light to travel only between the corresponding phosphor-photodiode pair. For example, this would mean that no light from phosphor 112a can reach the photodiode 46b. The embodiment shown in FIG. 5 may, in another example embodiment, use the same or similar phosphor elements 112a, 112b with the emission of each element 112a, 112b filtered to pass a specific band in order to allow the module 114 to distinguish between different sensing points.

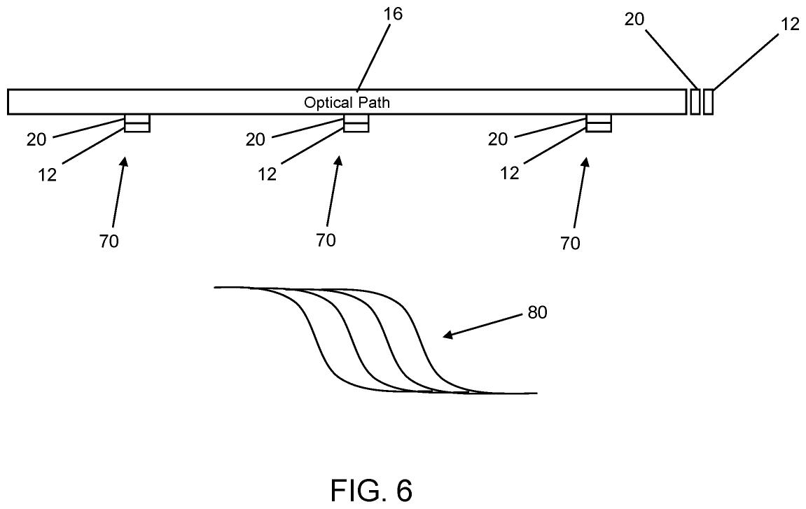

FIG. 6 illustrates yet another example embodiment, in which the optical path 16 includes a plurality of optical elements 70 comprising materials chosen to match the index of refraction of the optical path 16 (also referred to herein as “index matching elements 70”) along its length. Each index matching element 70 may be integrated with the optical path 16 by placing the sensor of the element 70 in optical contact with the core of the fiber used in the optical path 16, e.g., by cutting back the cladding around the core to provide such optical contact when the index matching element 70 is coupled to the optical path 16. The index matching elements 70 each match to an index of the optical fiber. Optical fibers keep light internal to the fiber by having a cladding of a different index of refraction, which reflects light inside the fiber back into the fiber when it encounters the different refractive index of the cladding. If the cladding of the fiber has the same index of refraction as the core of the optical fiber for some short length, some light will escape the fiber and reach the sensor element. This allows for multiple index matching elements 70 to be placed along the length of one optical fiber 16 instead of just one at the end of each optical fiber 16.

In various embodiments, an index matching element 70 may include a filter 20 and a phosphor sensing element 12 shown in FIG. 6. In various embodiments, multiple index matching elements 70 may have the same or essentially the same filter 20 (for example the same transmission spectrum) and the same or essentially the same phosphor element (for example the same emission spectrum) and in these embodiments the temperature at the locations of these multiple index matching elements 70 may be measured together. In various embodiments, this may be termed a bulk temperature, meaning one temperature value reported for measurements made at more than one location. In various embodiments, this may mean an average of the temperatures measured at each location, however in other embodiments the bulk temperature may be determined differently. However, in other embodiments different sensing elements may have different filters 20 (for example different transmission spectra) and the same or essentially the same phosphor elements (for example the same emission spectrum) and/or different phosphor elements (for example different emission spectra) and in these embodiments the system may be able to distinguish the temperature at the different locations of the different index matching elements.

Waveforms 80 in FIG. 6 illustrate the cut offs or band filters applied by the different index matching elements 70 and correspond to different sensor locations. Multiple ones of the same band filters or a combination of different band filters, some the same and some at different wavelengths, may be placed along the optical path 16 to acquire bulk temperature measurements over one set of sensing locations and to acquire different bulk temperature measurements from other sets of sensing locations. It can be appreciated that the index matching elements 70 would be coupled to a measurement module 14 or other system, that may or may not include a computing device (e.g., as shown in FIGS. 3, 4A, 4B). For example, a time constant calculation may be performed on a PCBA in a microcontroller or using some other form of signal processing, which then passes the temperature signal to a controller 50 or computer. As such, FIG. 6 is shown schematically and in isolation for ease of illustration.

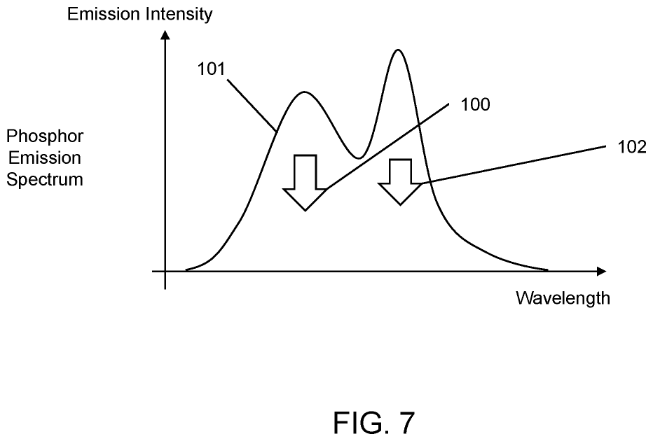

FIGS. 7 to 11 show a decomposition of the emission spectrum to improve accuracy and to reduce the effect of cable length variation on accuracy. FIG. 7 illustrates an example phosphor emission spectrum 101 plotted as the emission intensity as a function of wavelength. The band of the spectrum 101 may exhibit a first decay rate 100 while another band of the spectrum 101 exhibits a second decay rate 102.

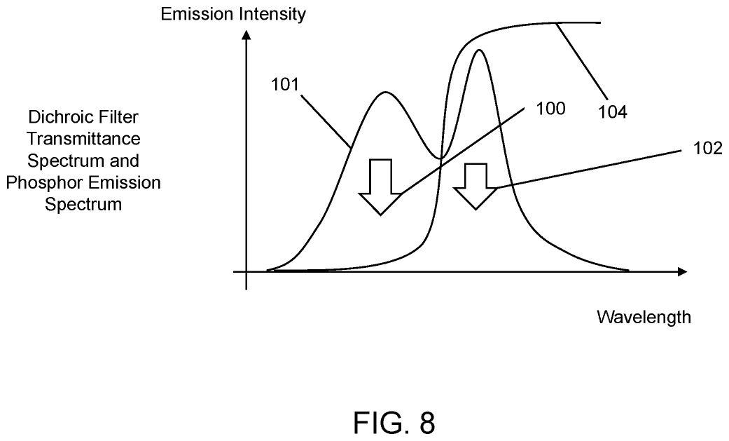

FIG. 8 illustrates an example transmittance spectrum 104 of a dichroic mirror along with the example phosphor emission spectrum 101 shown in FIG. 7 to illustrate a filtering to obtain the second decay rate 102, in other words to separate the second decay rate 102 from the first decay rate 100. The example transmission spectrum 104 may represent the transmittance of the dichroic mirror or it may also be the reflectance of the dichroic mirror depending on its type—i.e., one can use a long-pass (reflects short wavelengths) or short-pass (reflects long wavelengths) type. The dichroic mirror, for example the mirror 36 or 40 discussed in reference to FIG. 5) acts as a filter and enables splitting of the different portions of the emission spectrum 101 into two bands in this example (but could be more, up to N as shown herein), such that the signals can be processed separately.

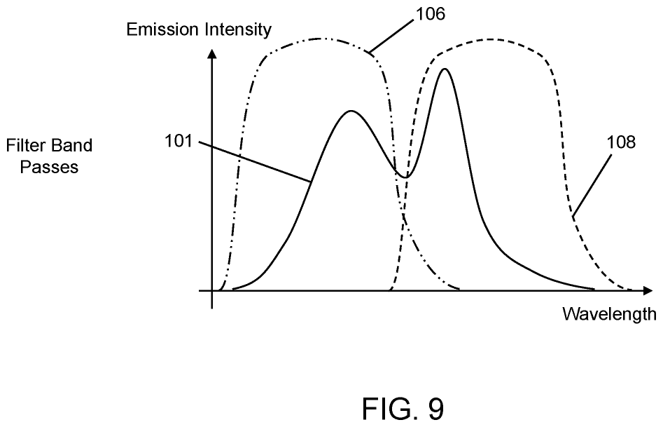

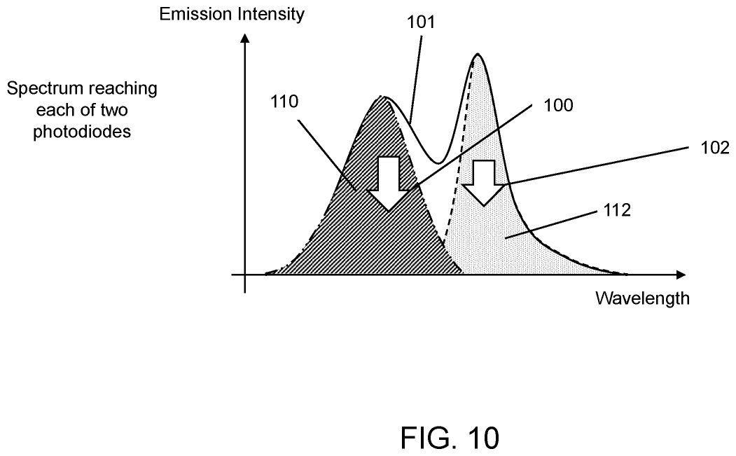

FIG. 9 shows an example pair of transmission curves 106 and 108 for a pair of bandpass filters overlaid on an emission spectrum 101 as described in reference to FIGS. 7 and 8. FIG. 10 shows example spectra 110, 112 reaching each of two photodiodes (e.g., 46a, 46b in FIG. 3) after being filtered through the bandpass filters having example transmission curves 106 and 108 shown in FIG. 9. The first decay rate 100 is therefore associated with the first portion of the emission spectrum 110 and the second decay rate 102 is associated with a second portion of the emission spectrum 112.

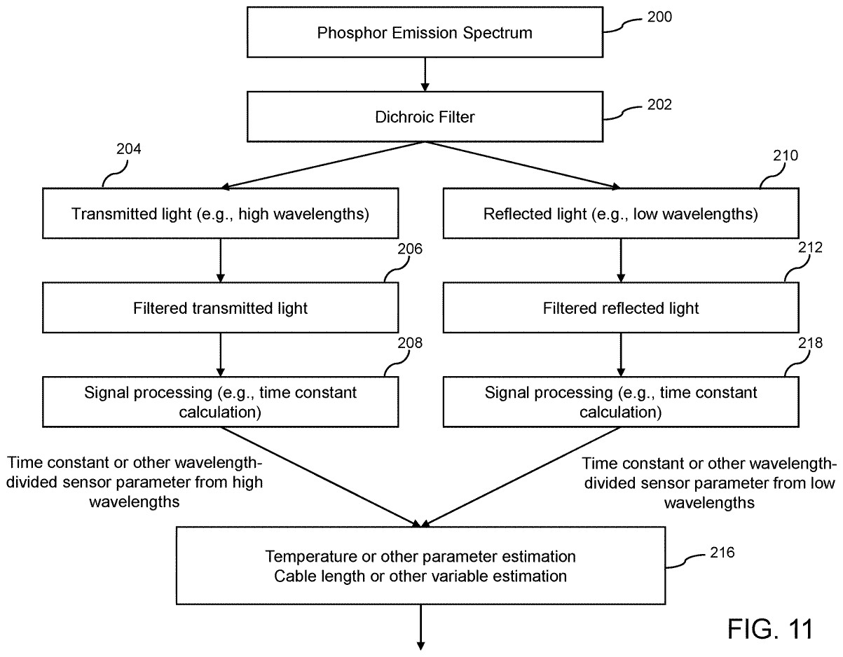

FIG. 11 illustrates a flow chart of the decomposition process, for example, to improve accuracy and reduce cable length variation, as shown in FIGS. 7-10. The phosphor emission spectrum at block 200 reaches a dichroic filter at block 202, which separates the light into transmitted light at block 204 and reflected light at block 210. The transmitted light (e.g., high wavelengths) is filtered to generate filtered transmitted light at block 206 which is incident on a first photodetector and signal processing is applied at block 208, e.g., to calculate a time constant). The reflected light (e.g., low wavelengths) is filtered to generate filtered reflected light at block 212, which is incident on a second photodetector and processed at block 218, e.g., to calculate a time constant for the band of the emission spectrum associated with the reflected light. At block 216, a temperature or other parameter is estimated and/or a cable length or other variable is estimated using the calculations performed at blocks 208 and 218.

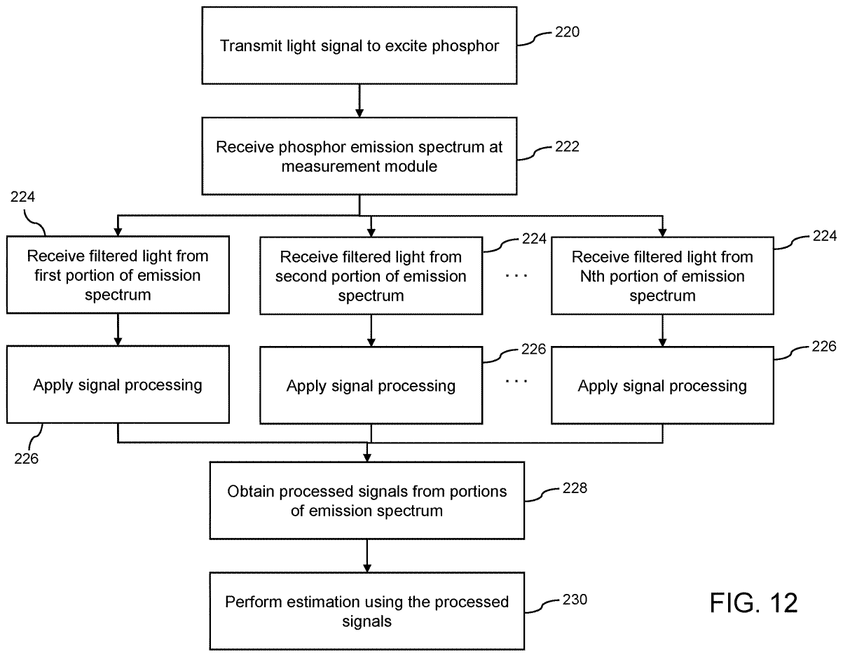

A method of performing the decomposition process in FIG. 11 is shown in FIG. 12, which illustrates operations that can be performed in decomposing an emission spectrum into multiple bands, for example to improve accuracy of a parameter or variable estimation. At step 220, the module 14 transmits a light signal to excite the phosphor 12. At step 222, a phosphor emission spectrum is received by the measurement module 14. The measurement module 14 uses dichroic mirrors and/or other elements (e.g., as exemplified in FIGS. 3, 4A, 4B) to split the emission spectrum into N portions or bands to be processed, i.e., first band, second band, . . . Nth band. At step 224, each measurement sub-system receives filtered light from the first, second, up to Nth portions and at step 226, signal processing is applied to each measurement band. The processed signals can then be combined, compared or otherwise considered at the same time at step 228 to obtain processed signals from the portions of the emission spectrum and to perform an estimation using the processed signals at step 230.

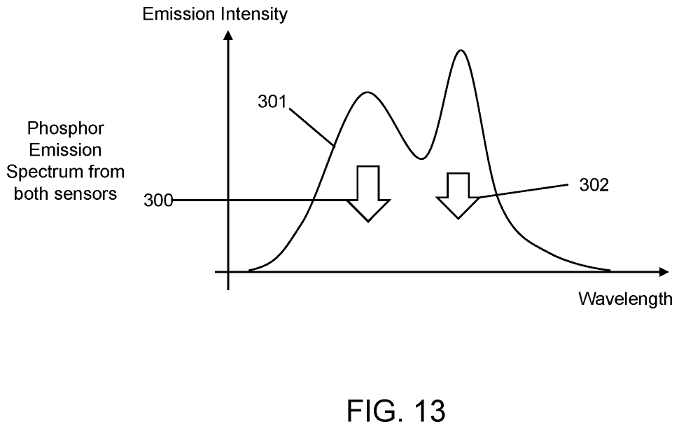

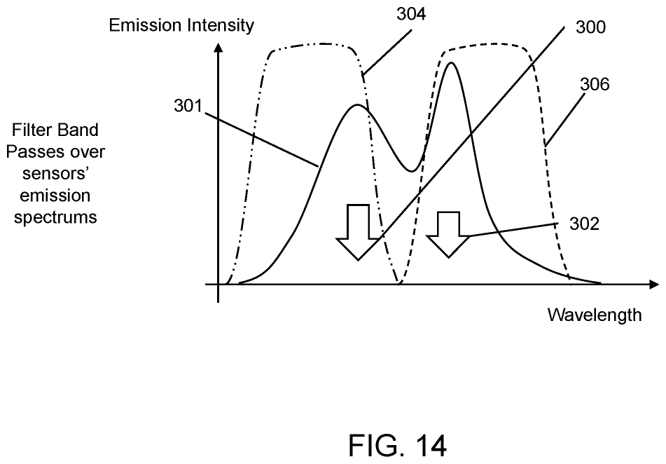

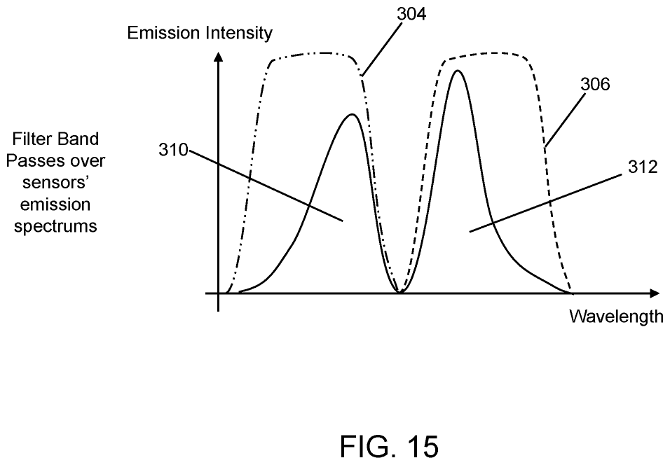

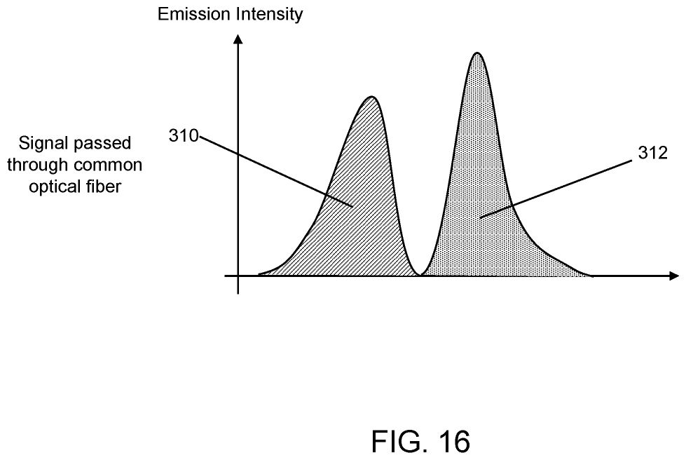

Referring now to FIGS. 13 to 21, multiple sensor transmission over one optical path 16 is illustrated, e.g., using the example embodiments shown in FIGS. 2 and 5. In FIG. 13, an example emission spectrum 301 may have a first decay rate 300 and a second decay rate 302. In various embodiments, bandpass filters, (e.g., bandpass filters 20a, 20b, 20c, . . . , 20N as described in reference to FIG. 2A), may have example transmission curves 304, 306 which are overlaid on the example emission spectrum 301 in FIG. 14. FIG. 15 shows the example spectra 310, 312 after having been filtered through example transmission curves 304, 306 of the bandpass filters to illustrate the separation of a first signal 310 (FIG. 14) and a second signal 312 relative to the signal 301 passed through the common optical path 16, as shown in FIG. 16.

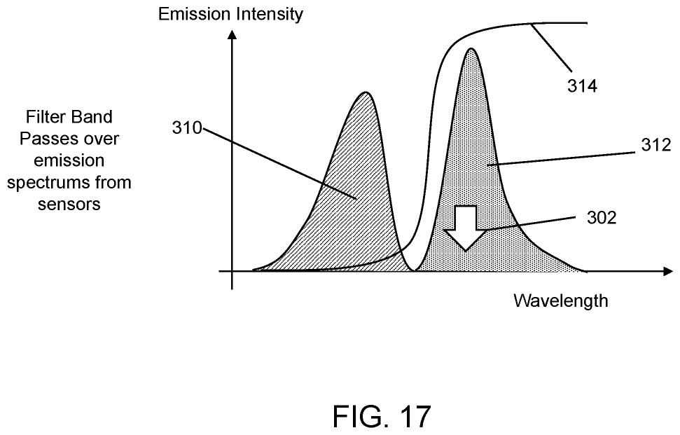

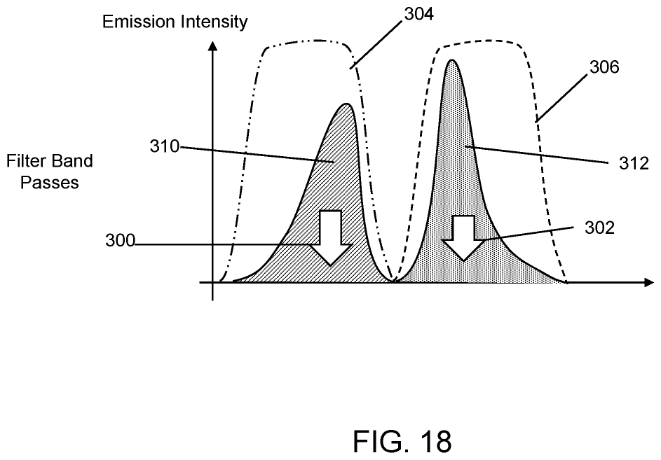

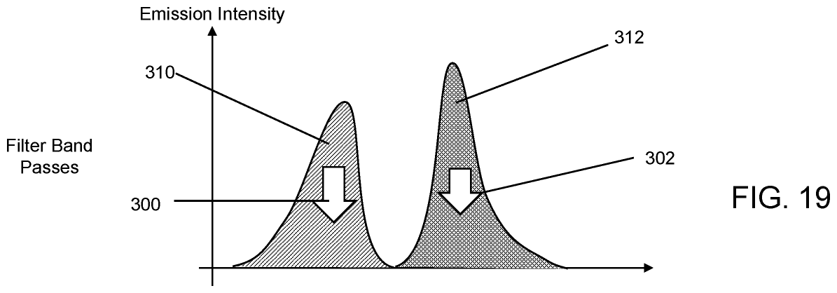

FIG. 17 illustrates an example transmittance spectrum 314 for a dichroic filter along with the example phosphor emission spectrum 301 shown in FIG. 16 to illustrate a filtering to obtain the second decay rate 302. Example band pass filter transmission spectra 304 and 306 are again shown in FIG. 18 to show the further filtering in the module 14 to allow separation of first and second decay rates 300 and 302 respectively. FIG. 19 shows the resulting first decay rate 300 and the second decay rate 302.

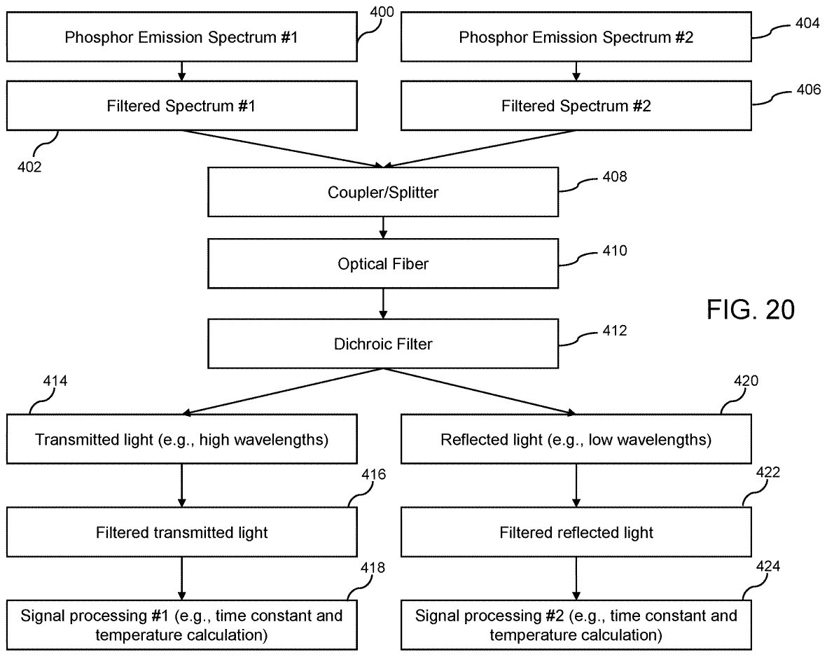

FIG. 20 illustrates the multiple sensor transmission embodiment over one optical path 16. At block 400, the phosphor emission spectrum from the first phosphor element 12a is filtered at block 402 to generate a first filtered spectrum, referred to as filtered spectrum 1. Similarly, at block 404, the phosphor emission spectrum from the second phosphor element 12b is filtered at block 406 to generate filtered spectrum 2. A coupler or splitter along the optical path 16 is used at block 408 to direct the filtered spectrums to the optical fiber at block 410. The signal then reaches a dichroic filter at block 412 to generate transmitted light (e.g., high wavelengths) at block 414 and reflected light (e.g., low wavelengths) at block 420. The transmitted light at block 414 is filtered to generate filtered transmitted light at block 416 and a first signal processing stage (signal processing 1) is performed at block 418, e.g., to determine a time constant and temperature calculation for the first phosphor element 12a. Similarly, the reflected light is filtered at block 422 to generate filtered reflective light, which is used to perform a second signal processing stage (signal processing 2) at block 424.

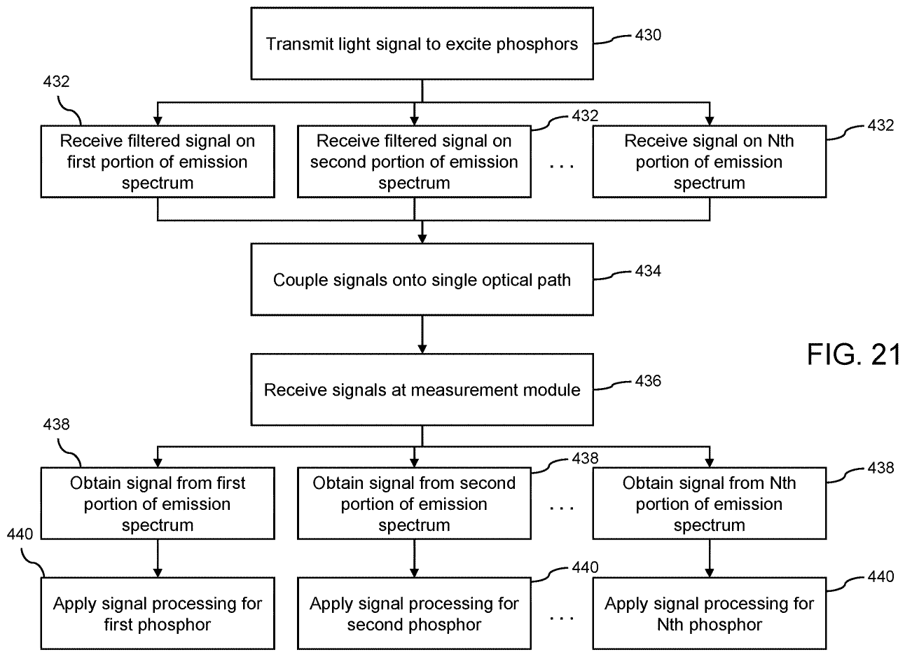

A method of performing the decomposition process in FIG. 20 is shown in FIG. 21, which illustrates operations that may be performed in processing multiple sensors.

Referring back to FIG. 20, FIG. 20 illustrates the decomposition process. At block 400 and 404, phosphor emission spectra 1, 2 respectively are generated (more than two are also within the scope of the invention). The different phosphor emission spectra 1,2 are filtered in blocks 402 and 406 respectively and then optically coupled together into a single optical path in block 434, transmitted down the optical path in block 410 and separated by a dichroic filter in a long wavelength portion at block 414 and a short wavelength portion at block 420. The short and long wavelength portions are then filtered in blocks 416 and 422 respectively and directed to photodetectors which produce a signal from which a time calculation or time constant may be calculated in blocks 418 and 424.

Referring to FIG. 21, at step 430 the system transmits a light signal to excite the phosphors 112a, 112b, . . . 112N. At step 432, a filtered signal is received from each emission spectrum, namely in this example a first portion of the emission spectrum, a second portion of the emission spectrum and so forth up to an Nth portion of the emission spectrum. That is, each phosphor element 112a, 112b, . . . 112N uses a band of the emission spectrum to enable the measurement module 224 to distinguish a respective measurement point. The signals are coupled onto the single optical path 16 at step 434 and the signals are received at the measurement module 214 at step 436. Using the dichroic mirrors and/or other elements as illustrated herein, the measurement module 214 obtains a signal from each of the phosphor elements 112a, 112b, . . . , 112N at step 438, namely in this example using a first portion of the emission spectrum, a second portion of the emission spectrum, and so forth up to the Nth portion of the emission spectrum. This enables the measurement module 214 to apply signal processing to each band individually at step 440, in this example to obtain a measurement for the first phosphor element 112a, the second phosphor element 112b, and so forth up to the Nth phosphor element 112N.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different embodiments, configurations, and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the system or any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. A temperature measurement system, comprising:
a phosphor sensing element;
a light source configured to be modulated and to excite the phosphor sensing element and generate an optical excitation response signal from the phosphor sensing element, wherein the optical excitation response signal includes an emission spectrum;
a first detector element and a second detector element, wherein the first detector element is configured to detect a first portion of the emission spectrum and the second detector element is configured to detect a second portion of the emission spectrum, wherein the first portion of the emission spectrum is different from the second portion of the emission spectrum; and
a controller configured to determine a temperature of the phosphor sensing element based on at least one time-varying temperature-dependent parameter of at least one of the first portion of the emission spectrum and the second portion of the emission spectrum.

54. The temperature measurement system of claim 53, wherein the at least one time-varying temperature-dependent parameter comprises a decay of at least a portion of the first emission spectrum and the second emission spectrum respectively.

55. The temperature measurement system of claim 54, wherein the decay of at least a portion of the first emission spectrum and the second emission spectrum respectively comprise a time constant of at least a portion of the first emission spectrum and the second emission spectrum respectively.

56. The temperature measurement system of claim 53, wherein the light source is modulated between an on state and an off state and the temperature of the phosphor sensing element is determined based on the at least one time-varying temperature-dependent parameter detected during at least a portion of the off state.

57. The temperature measurement system of claim 53, further comprising:
an optical path having a proximal end and a distal end, wherein the distal end is optically coupled to the phosphor sensing element;
a measurement module optically coupled to the proximal end, the measurement module comprising:
the light source, wherein the light source is optically coupled to the proximal end of the optical path;
one or more optical elements optically coupled to the optical path, configured to separate the emission spectrum of the optical excitation response signal into at least two bands of the emission spectrum;
the first detector element and the second detector element are configured to detect a respective one of the at least two bands of the emission spectrum, thereby creating at least one detected signal associated with each of the at least two bands of the emission spectrum;
the optical path is configured to convey the optical excitation signal from the light source to the phosphor sensing element and to convey the optical excitation response signal from the phosphor sensing element to the one or more optical elements; and
a controller coupled to the light source, the first detector element, and the second detector element, to enable the temperature measurement system to process the at least two detected signals, wherein the controller is configured to calculate a temperature of the phosphor sensing element based on at least one time-varying temperature-dependent parameter of at least one of the at least two bands of the emission spectrum.

58. The temperature measurement system of claim 53, further comprising a computing device coupled to the controller.

59. The temperature measurement system of claim 53, wherein the light source comprises at least one of a light emitting diode (LED) and a laser.

60. The temperature measurement temperature measurement system of claim 57, wherein at least one of the one or more optical elements comprises a dichroic mirror.

61. The temperature measurement system of claim 57, wherein the measurement module includes a spectrometer.

62. The temperature measurement system of claim 57, wherein the measurement module further comprises a photodiode array coupled to the spectrometer via a plurality of optical paths.

63. A temperature measurement system, comprising:
a first phosphor sensing element and a second phosphor sensing element;
a light source configured to be modulated and to excite the first phosphor sensing element and the second phosphor sensing element and generate a first optical excitation response signal and a second optical excitation response signal from the first phosphor sensing element and the second phosphor sensing element, wherein the first excitation response signal and the second optical excitation response signal include a first emission spectrum and a second emission spectrum, respectively;
a first detector element and a second detector element, wherein the first detector element is configured to detect at least a portion of the first emission spectrum and the second detector element is configured to detect at least a portion of the second emission spectrum, wherein the at least a portion of the first emission spectrum is different from the at least a portion of the second emission spectrum; and
a controller configured to determine a temperature of the first phosphor sensing element and the second phosphor sensing element based on at least one time-varying temperature-dependent parameter of the at least a portion of the first emission spectrum and the at least a portion of the second emission spectrum.

64. The temperature measurement system of claim 63, wherein a first phosphor element is spaced apart from the second phosphor element.

65. The temperature measurement system of claim 63, wherein the first phosphor element is different from the second phosphor element.

66. The temperature measurement system of claim 63, wherein the first phosphor element is the same as the second phosphor element.

67. The temperature measurement system of claim 63, wherein the at least one time-varying temperature-dependent parameter comprises a decay of at least a portion of the first emission spectrum and at least a portion of the second emission spectrum.

68. The temperature measurement system of claim 67, wherein the decay of at least a portion of the first emission spectrum and the second emission spectrum respectively comprise a time constant of at least a portion of the first emission spectrum and the second emission spectrum respectively.

69. The temperature measurement system of claim 67, wherein the light source is modulated between an on state and an off state and the temperature of the phosphor sensing element is determined based on the at least one time-varying temperature-dependent parameter detected during at least a portion of the off state.

70. The temperature measurement system of claim 69, wherein the controller is configured to determine a temperature of the first phosphor sensing element and the second phosphor sensing element based on at least one time-varying temperature-dependent parameter of the at least a portion of the first emission spectrum and the second emission spectrum respectively, during at least a portion of the off state.

71. The temperature measurement system of claim 63, further comprising a computing device coupled to the controller.

72. The temperature measurement system of claim 63, wherein the light source comprises at least one of a light emitting diode (LED) and a laser.

73. The temperature measurement system of claim 63, further comprising:
an optical path having a proximal end and a distal end, the distal end optically coupled to a first optical branch and a second optical branch, each of the first optical branch and the second optical branch terminating at a first sensing location and second sensing location respectively, each of the first sensing location and second sensing location comprising at least one first filter and at least one second filter disposed between the first optical branch and the second optical branch and the first phosphor sensing element and second phosphor sensing element respectively;
wherein the light source is optically coupled to the proximal end of the optical path and is configured to:
(i) be modulated and
(ii) to generate an optical excitation signal to excite the first phosphor sensing element and the second phosphor sensing element and generate a first optical excitation response signal and a second optical excitation response signal from the first phosphor sensing element and the second phosphor sensing element respectively;
wherein
(i) the optical path and the first optical branch and the second optical branch are configured to convey the optical excitation signal from the light source to the first phosphor sensing element and the second phosphor sensing element,
(ii) the first optical excitation response signal and the second optical excitation response signal include a first emission spectrum and a second emission spectrum respectively and
(iii) the at least one first filter and the at least one second filter are configured to pass a band of the first emission spectrum and the second emission spectrum respectively, thereby creating a combined emission spectrum comprising the first filtered emission spectrum and the second filtered emission spectrum;
one or more optical elements optically coupled to the optical path, wherein
(i) the first optical branch, the second optical branch, and the optical path are configured to convey the combined emission spectrum to the one or more optical elements, and;
(ii) the one or more optical elements are configured to separate the combined emission spectrum into a plurality of bands of the combined emission spectrum;
a plurality of detector elements, each configured to detect a respective one of the bands of the combined emission spectrum, thereby creating a detected signal for each of the plurality of bands of the combined emission spectrum;
a controller coupled to the light source and the plurality of detector elements, to enable the temperature measurement system to process each detected signal, wherein the controller is configured to calculate a temperature of the first phosphor sensing element and the second phosphor sensing elements based on at least one time-varying temperature-dependent parameter of at least two of the plurality of bands of the combined emission spectrum.

74. The temperature measurement system of claim 73, wherein at least one of the one or more optical elements comprises at least one dichroic mirror.

75. The temperature measurement system of claim 73, wherein the at least one filter comprises at least one of a bandpass filter, a low pass filter, or a high pass filter, and the at least one filter is characterized by a transmission spectrum.

76. The temperature measurement system of claim 73, wherein the first phosphor sensing element and the second phosphor sensing element are the same and at least one of the at least one first filter and the at least one second filter in the first optical branch has a different transmission spectrum than at least one of the at least one first filter and the at least one second filter in the second optical branch.

77. The temperature measurement system of claim 73, wherein the first phosphor sensing element is different from the second phosphor sensing element and the at least one first filter has a different transmission spectrum than the at least one second filter.

78. The temperature measurement system of claim 73, wherein at least one of the at least one first filter and the at least one second filter are configured to transmit the optical excitation signal.

79. The temperature measurement system of claim 73, further comprising a spectrometer.

80. The temperature measurement system of claim 79, further comprising a photodiode array coupled to the spectrometer via a plurality of optical paths.
